(19) United States
(12) Patent Application Publication
(10) Pub. No.: US 2003/0108790 A1
(43) Pub. Date: Jun. 12, 2003

(54) Surface/chemically modified oxide cathodes for lithium-ion batteries

(76) Inventors: Arumugam Manthiram, Austin, TX (US); Arunachala Nadar Mada Kannan, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/010,858

(22) Filed: Dec. 5, 2001

(51) Int. Cl. H01M 4/52

(52) U.S. Cl. 429/218.1; 429/232; 429/231.1

(57) ABSTRACT

Embodiments include a process and composition for improved capacity retention of a lithium-ion battery. Embodiments include a surface/chemical modification of electrode materials. In certain embodiments the LiMn₂O₄ spinel oxide is modified with LiₓCoO₂, LiₓNi_{0.5}Co_{0.5}O₂, Al₂O₃, Cr₂O₃, MgO, MgAl₂O₄ or combinations thereof using a chemical processing procedure followed by heat treatment. The surface/chemically modified LiMn₂O₄ show an improved capacity retention at room temperature and at elevated temperatures. In certain embodiments, LiₓNi_{0.5}Co_{0.5}O₂-modified LiMn₂O₄ demonstrates improved capacity retention. In other embodiments, Al₂O₃-modified LiMn₂O₄ demonstrates a higher capacity under certain conditions. In other embodiments the Li_{0.75}CoO₂-modified LiMn₂O₄ demonstrates a combination of improved capacity value and retention. In another embodiment the LiCoO₂ layered oxide is modified with Al₂O₃ or Li_{1.05}Mn_{1.9}Ni_{0.05}O₄ using a chemical processing procedure followed by heat treatment. The surface/chemically modified LiCoO₂ shows much higher capacity of approximately 190 mAh/g in the range of 4.5 to 3.2 V with good capacity retention.

### FIELD OF THE INVENTION

The present invention relates generally to compositions useful for energy conversion and storage. More particularly, it relates to compositions and methods of preparation of electrode materials for lithium-ion batteries. Embodiments include the preparation and use of chemically modified spinel lithium manganese oxide and layered lithium cobalt oxide.

### BACKGROUND

Lithium-ion cells have become attractive for portable electronic devices such as cellular phones and laptop computers as they offer higher energy density than other rechargeable systems. Commercial lithium-ion cells currently use mostly the layered LiCoO₂ cathodes, but Co is relatively toxic and expensive. Also, only 50% of the theoretical capacity of LiCoO₂ could be practically utilized (140 mAh/g), which corresponds to a reversible extraction of 0.5 lithium ions per cobalt ion. Additionally, the highly oxidizing nature of the Co^{3+/4+} couple poses safety concerns at deep charge. These difficulties of LiCoO₂ cathodes have created enormous worldwide interest to develop alternative cathode hosts. In this regard, the spinel LiMn₂O₄ is of interest because manganese is inexpensive and environmentally benign.

However, the LiMn₂O₄ spinel oxide that has been investigated extensively over the years tends to exhibit capacity fade during cycling; the capacity fading is severe especially above 40° C. Several factors such as manganese dissolution, formation of oxygen deficiency, electrolyte decomposition, and Jahn-Teller distortion have been reported to be responsible for the capacity fade. The dissolution of manganese from the lattice into the electrolyte is due to a disproportionation of manganese that is in contact with the LiPF₆ electrolyte in accordance with the reaction, 2Mn³⁺_{(solid)}→Mn⁴⁺_{(solid)}+Mn²⁺₍ₛₒₗᵤₜᵢₒₙ₎.

Several attempts have been made to overcome the problems of capacity fade. For example cationic substitutions for manganese have been found to improve the capacity retention at room temperature. However, the capacity fading at elevated temperatures could not be fully overcome. Recently, there have been reports on the improvement of the high temperature performance of LiMn₂O₄ cathodes by coating its surface with LiCoO₂ and V₂O₅. For example, a capacity fading of about 0.08% per cycle over 100 cycles has been found at 55° C. and C/5 rate with the LiCoO₂-coated LiMn₂O₄ sample. Similarly, a coating of LiCoO₂ with Al₂O₃ has been reported to increase its specific capacity. There is still a need for further improvement in the capacity retention of LiMn₂O₄-based lithium ion cells as well as in the specific capacity of LiCoO₂-based lithium-ion cells.

### SUMMARY OF THE INVENTION

Embodiments of the invention include compositions and methods of surface and/or chemically modifying oxide cathodes for batteries. The compositions typically show an improved capacity retention, lower cost of production, and reduced environmental concerns. In certain embodiments, methods include the mixing and firing of a guest modification material that may chemically modify the surface of an electrode material with a an electrode material to fabricate an oxide cathode for batteries.

Embodiments of the invention include surface/chemically modified electrode materials for lithium-ion batteries comprising a surface/chemically modified positive electrode (cathode) material, wherein a guest chemical modification material(s) is selected from LiₓNi_{1-y}M_{y}O₂, where 0≦x≦1, 0≦y≦1, and M=Mg, Al, Ti, V, Cr, Fe, Co, Cu, Zn, and Ga; Al₂O₃; Cr₂O₃; MgO; Al_{2-y}Mg_{y}O_{3-0.5y} where 0≦y≦2; Li₁₊ₓMn_{2-x-y}M_{y}O₄ where 0≦x≦0.33, 0≦y≦2 and M=Mg, Al, Ti, V, Cr, Fe, Co, Ni, Cu and Zn; Zr_{1-y}M_{y}O_{2-y} where 0≦y≦1 and M=Mg, Ca; Zr_{1-y}M_{y}O_{2-0.5y} where 0≦y≦1 and M=Sc, Y; and combinations thereof. In certain embodiments, the host cathode material is selected from LiCoO₂, LiMn₂O₄, LiNi_{1-y}Co_{y}O₂ where 0≦y≦1 and LiMn_{1-y}M_{y}O₂ where M=Cr and Al and 0≦y≦1, and Li₁₊ₓMn_{2-x-y}M_{y}O_{4-x+δ}X_{z} where 0≦x≦0.33, 0≦y≦1, 0≦δ≦0.5, M=Mg, Al, Ti, V, Cr, Fe, Co, Ni, Cu and Zn, and X=F and S. In particular embodiments the host cathode material is spinel LiMn₂O₄ oxide. In alternative embodiments the host cathode material is LiCoO₂. In one embodiment the guest chemical modification material is LiₓNi_{1-y}CO_{y}O₂, where 0≦x≦1; 0≦y≦1. In alternative embodiments the guest chemical modification materials are Al₂O₃, Cr₂O₃, MgO, MgAl₂O₄, and Li₁₊ₓMn_{2-x-y}Ni_{y}O₄.

Another embodiment includes a method of preparing an electrode material for lithium-ion batteries including supplying a LiMn₂O₄ spinel oxide electrode material; chemically processing the LiMn₂O₄ spinel oxide electrode material with a guest chemical modification material selected from LiₓNi_{1-y}Co_{y}O₂ (where 0≦x≦1; 0≦y≦1), Al₂O₃, Cr₂O₃, MgO, MgAl₂O₄, and combinations thereof; and heat-treating (firing) the mixture to prepare a surface/chemically modified LiMn₂O₄ electrode material or selecting a LiCoO₂ layered oxide electrode material; chemically processing the LiCoO₂ layered oxide electrode material with a guest chemical modification material selected from Al₂O₃, Li₁₊ₓMn_{2-x-y}Ni_{y}O₄ where 0≦x≦0.33, and combinations thereof; and heat-treating (firing) the mixture to prepare a surface/chemically modified LiCoO₂ electrode material. In one embodiment heat-treating is performed at a temperature in the approximate range of 100° C. to 1000° C. for approximately 1 to 24 hours. In certain embodiments the chemical modification materials are in the approximate range of 1 to 20 weight percent of the electrode material to be surface/chemically modified.

In certain embodiments a surface/chemically modified LiMn₂O₄ spinel oxide or LiCoO₂ layered oxide electrode material is prepared by a process including a) refluxion of a precursor solution in glacial acetic acid, wherein the precursor is selected from LiₓCoO₂, LiCo_{0.5}Ni_{0.5}O₂, Al₂O₃, Cr₂O₃, MgO, MgAl₂O₄, Li_{1.05}Mn_{1.9}Ni_{0.05}O₄ and combinations thereof, b) preparation of a precursor solution in water, wherein the precursor is selected from Al₂O₃, Cr₂O₃, MgO, MgAl₂O₄ and combinations thereof, c) dispersing LiMn₂O₄ spinel oxide or LiCoO₂ layered oxide in the precursor solution; and d) heating the dispersed LiMn₂O₄ spinel oxide or LiCoO₂ layered oxide to approximately 30 to 400° C.; and d) firing the heated dispersed LiMn₂O₄ spinel oxide or LiCoO₂ layered oxide at 200-900° C.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates an exemplary comparison between the first and 100th discharge profiles of a LiMn₂O₄ cathode and a surface/chemically modified LiMn₂O₄ cathode at room temperature with a current density of 0.5 mA/cm² (C/2 rate).

FIG. 2 illustrates an exemplary comparison of cyclability data of LiMn₂O₄ with those of a number of surface/chemically modified LiMn₂O₄ cathodes at room temperature with a current density of 0.5 mA/cm² (C/2 rate).

FIG. 3 illustrates an exemplary comparison of cyclability data of LiMn₂O₄ with those of a number of surface/chemically modified LiMn₂O₄ cathodes at room temperature with a current density of 0.5 mA/cm² (C/2 rate).

FIG. 4 illustrates an exemplary comparison of cyclability data of LiMn₂O₄ with those of a number of surface/chemically modified LiMn₂O₄ cathodes at 60° C. with a current density of 0.5 mA/cm² (C/2 rate).

FIG. 5 illustrates an exemplary comparison of the cyclability data of LiMn₂O₄ and the surface/chemically modified LiMn₂O₄ cathodes at a higher current density of 2 mA/cm² (2C rate) at room temperature.

FIG. 6 illustrates an exemplary comparison of the X-ray diffraction patterns of LiMn₂O₄ and the surface/chemically modified LiMn₂O₄ spinel cathodes in discharged state after cycling at 60° C. over 100 cycles.

FIG. 7 illustrates an exemplary comparison of cyclability data of LiCoO₂ and Al₂O₃ modified LiCoO₂ at room temperature and at 60° C. in different voltage ranges of 4.3-3.2, and 4.5-3.2 at C/5 rate.

### DESCRIPTION OF THE INVENTION

In certain embodiments of the invention, capacity retention of a lithium-ion battery electrode material is improved by surface/chemical modification. Surface/Chemical modification of oxide electrode materials is typically performed by using a variety of materials including, but not limited to, LiₓCoO₂, LiₓCu_{0.5}Ni_{0.5}O₂, LiₓCo_{0.75}Ni_{0.75}O₂, Al₂O₃, MgO, MgAl₂O₄, and Li_{1.05}Mn_{1.9}Ni_{0.05}O₄; where 0≦x≦1.

Chemically Modified LiMn₂O₄ Cathodes

In certain embodiments the surface of LiMn₂O₄ spinel oxide is modified to improve capacity retention. The surface/chemically modified LiMn₂O₄ demonstrates an improved capacity retention as compared to unmodified LiMn₂O₄ spinel oxide both at ambient temperature and at elevated temperatures. In certain embodiments the surface of LiMn₂O₄ spinel oxide is modified with surface modification materials such as LiₓCoO₂, LiₓNi_{0.5}Ni_{0.5}O₂, Al₂O₃, MgO, and/or MgAl₂O₄ (where 0≦x≦1). Surface/chemical modification protects the spinel particles from attack by the acidic species present in the electrolyte and leads to maintenance of good structural integrity during cycling. The surface/chemically modified LiMn₂O₄ spinel oxides may in fact offer better long-term cyclability characteristics and safety features than the commercially used LiCoO₂ cathodes. The lower cost coupled with high rate capability and excellent cycling properties make the surface/chemically modified LiMn₂O₄ cathodes attractive for energy storage for a variety of uses including, but not limited to cell phones, laptop computers, electric vehicles, and the like.

In one embodiment the surface/chemical modification of LiMn₂O₄ using a LiNi_{0.5}Co_{0.5}O₂, as described herein, provides superior capacity retention. In another embodiment the surface/chemical modification of LiMn₂O₄ using Li_{0.75}CoO₂, as described herein, provides a superior combination of capacity value and capacity retention.

Surface/Chemically-Modified LiCoO₂ Cathodes

Typically, commercial lithium ion batteries use the layered LiCoO₂ oxide cathodes, as they offer better cyclability. However, only 50% of its theoretical capacity could be practically utilized, which corresponds to a reversible extraction/insertion of 0.5 lithium ions per cobalt in LiCoO₂. This results in capacity fading above a cut-off charge voltage of approximately greater than 4.2 V. The limited capacity of LiCoO₂ may be due to its chemical instability and tendency to lose oxygen from lattice on extracting more than 0.5 lithium ions per cobalt.

In certain embodiments, chemical instability of LiCoO₂ may be overcome by surface/chemical modification with various compositions. The surface/chemically modified LiCoO₂ exhibits higher capacity than the unmodified LiCoO₂ layered oxide cathode both at room temperature and at elevated temperatures with good cyclability. In certain embodiments, the surface of LiCoO₂ is modified with surface/chemical modification materials such as Al₂O₃ and Li_{1.05}Mn_{1.9}Ni_{0.05}O₄. The surface/chemical modification may also improve the safety characteristics of the LiCoO₂ cathode.

Electrode Material

In certain embodiments the electrode material comprises LiMn₂O₄ or LiCoO₂. Alternatively, other materials including LiNi_{1-y}M_{y}O₂ where 0≦y≦1 and M=Ti, V, Cr, Mn, Fe, and Cu, LiMn_{1-y}M_{y}O₂ where 0≦y≦1 and M=Cr and Al, and Li₁₊ₓMn_{2-x-y}M_{y}O_{4-z+δ}X_{z} where 0≦x≦0.33, 0≦y≦1, 0≦δ≦0.5, M=Mg, Al, Ti, V, Cr, Fe, Co, Ni, Cu and Zn, and X=F and S may also be used as electrode materials.

Surface/Chemical Modification Materials

In certain embodiments surface/chemical modification materials may be a ceramic material, such as LiₓCoO₂, LiₓCo_{0.5}Ni_{0.5}O₂, Al₂O₃, Cr₂O₃, MgO, MgAl₂O₄, and/or Li_{1.05}Mn_{1.9}Ni_{0.05}O₄ (where 0≦x≦1) are used to modify the surface of electrode materials. Surface/chemical modification with LiCo_{0.5}Ni_{0.5}O₂ may show excellent capacity retention and superior rate capability with a capacity fade of <0.03% per cycle over 100 charge/discharge cycles at 60° C. and 0.5 mA/cm² (C/2 rate). Other potential surface modification materials include LiₓNi_{1-y}M_{y}O₂, where 0≦x≦1, 0≦y≦1, and M=Mg, Al, Ti, V, Cr, Fe, Co, Cu, Zn, and Ga; Al₂O₃; MgO; Al_{2-y}Mg_{y}O_{3-0.5}y where 0≦y≦2; Li₁₊ₓMn_{2-x-y}M_{y}O₄ where 0≦x≦0.33, 0≦y≦2 and M=Mg, Al, Ti, V, Cr, Fe, Co, Ni, Cu and Zn; Zr_{1-y}M_{y}O_{2-y} where 0≦y≦1 and M=Mg, Ca; Zr_{1-y}M_{y}O_{2-0.5y} where 0≦y≦1 and M=Sc, Y; and combinations thereof

Methods of Surface/Chemical Modification

In one embodiment, surface/chemical modified electrode materials are prepared by firing a mixture of electrode material and surface/chemical modifier. Firing temperatures may be in the approximate range of 100° C. to about 1000° C., preferably in the approximate range of 200° C. to 900° C., and also preferably in the approximate range of 300° C. to 800° C. A mixture of electrode material and surface/chemical modifier may be fired for various lengths of time, which may be in the approximate range of 1 to 24 h. Surface/chemical modification of an electrode material may be performed by treating various amounts of an electrode material with various amounts of surface/chemical modification material(s). The process typically results in a product with a surface/chemical modification material content in the range of about 1 weight percent to about 20 weight percent. The preferred surface/chemical modification material content in the approximate range of 2 to 5 weight percent. The process may involve dissolution of carbonates, nitrates or acetates of the surface/chemical modification material(s) in glacial acetic acid, refluxion of the mixture for about an hour, dispersion of an electrode material in a surface/chemical modifier solution, evaporation of the solvent, and decomposition of the resultant product at elevated temperature. The mixture is then fired at an elevated temperature in the presence or absence of a flowing oxygen atmosphere.

In another embodiment, the surface/chemical modifications with Al₂O₃, Cr₂O₃, MgO and MgAl₂O₄ may involve dispersion of an electrode material in an aqueous solution of aluminum, chromium or magnesium nitrate, formation/precipitation of a gelatinous Al(OH)₃, Cr(OH)₃ or Mg(OH)₂ over source material particles through the addition of ammonium hydroxide, and heating the resultant product at the approximate range of 100° C. to about 1000° C., preferably in the approximate range of 300° C. to 800° C., and also preferably in the approximate range of 300° C. to 400° C. for Al(OH)₃ and 400° C. to 600° C. for Cr(OH)₃ or Mg(OH)₂.

Other methods known in the art may be used to modify an electrode material as described herein, including chemical vapor deposition and other similar methods.

Electrode Fabrication

Electrodes for use in energy storage and conversion devices, including batteries, may be fabricated by further processing the composites disclosed herein by, for example, grinding to form an electrode. Examples of forming a battery electrode and battery are known to one of ordinary skill in the art. As used herein, “grinding” refers to mixing, crushing, pulverizing, pressing together, polishing, reducing to powder or small fragments, milling, ball milling, or any other suitable process to wear down a material. A conducting material may be mixed with the composites in the process of forming an electrode. The conducting material may be an electrically conductive material such as carbon, which may be in the form of graphite or acetylene black, but it will be understood with benefit of this disclosure that the conducting material may alternatively be any other material or mixtures of suitable materials known in the art.

Electrodes may be formed in a variety of shapes, sizes, and/or configurations as is known in the art. In one embodiment, electrodes may be formed by rolling a mixture of composites disclosed herein, conducting material, and binding material into one or more thin sheets which may be cut to form, for example, circular electrodes of various surface area, thickness, and weight. Electrochemical performance of such electrodes is typically evaluated according to procedures known in the art.

### EXAMPLES

### Surface/Chemical Modification of Electrode Material

The following examples are included to demonstrate various embodiments of the invention. It should be appreciated by those of skill in the art that the techniques disclosed in the examples which follow represent techniques that function in the practice of the invention. However, those of ordinarily skilled in the art may appreciate that many changes can be made in the specific embodiments which are disclosed without departing from the spirit and scope of the invention.

### Example 1

### Surface/Chemical Modification of LiMn₂O₄ Spinel Oxide

Material and Methods

A commercially available LiMn₂O₄ powder may be used as the host electrode material. The surface/chemical modification may be carried out by treating various amounts of LiMn₂O₄ powder with a precursor solution of LiₓCoO₂, LiₓCo_{0.5}Ni_{0.5}O₂, Al₂O₃, MgO, Cr₂O₃ or MgAl₂O₄ through a chemical process so that the amount of the guest modification material in the final product is approximately 3 to 5 wt %. The chemical process in the case of LiₓCoO₂, and LiₓCo_{0.5}Ni_{0.5}O₂ involve a dissolution of the carbonates or acetates of the precursor metal ions in glacial acetic acid, refluxion of the mixture for about an hour, dispersion of the LiMn₂O₄ spinel oxide in the precursor solution, evaporation of the solvent, and decomposition of the resultant product at around 400° C. The sample is then fired at 850° C. in flowing oxygen atmosphere. The surface/chemical modifications with Al₂O₃, Cr₂O₃, MgO and MgAl₂O₄ involve the dispersion of the LiMn₂O₄ spinel oxide in an aqueous solution of aluminum, chromium, or magnesium nitrate or a mixture of aluminum and magnesium nitrates, formation/precipitation of a gelatinous Al(OH)₃, Cr(OH)₃ or Mg(OH)₂ over LiMn₂O₄ particles through the addition of ammonium hydroxide, and heating the resultant product at 300° C. for Al(OH)₃ and at 600° C. for Cr(OH)₃ or Mg(OH)₂ in air.

The electrochemical performances of LiMn₂O₄ and the surface/chemically modified LiMn₂O₄ spinel oxide powders at both ambient and elevated temperatures are evaluated with coin cells. Cathodes are fabricated with the surface/chemically modified or unmodified LiMn₂O₄ powder, Denka black carbon, and polytetrafluoroethylene (PTFE) binder in a weight ratio of 75:20:5. The coin cells (CR2032) may be assembled with the cathodes thus fabricated, metallic lithium anodes, polyethylene separators, and 1 M LiPF₆ in ethylene carbonate (EC) and diethyl carbonate (DEC) electrolyte may be cycled at various current densities between the voltage range of approximately 3.5 to 4.3 V using a battery cycler (manufactured by Arbin Instruments, College Station, Tex.).

Results and Discussion

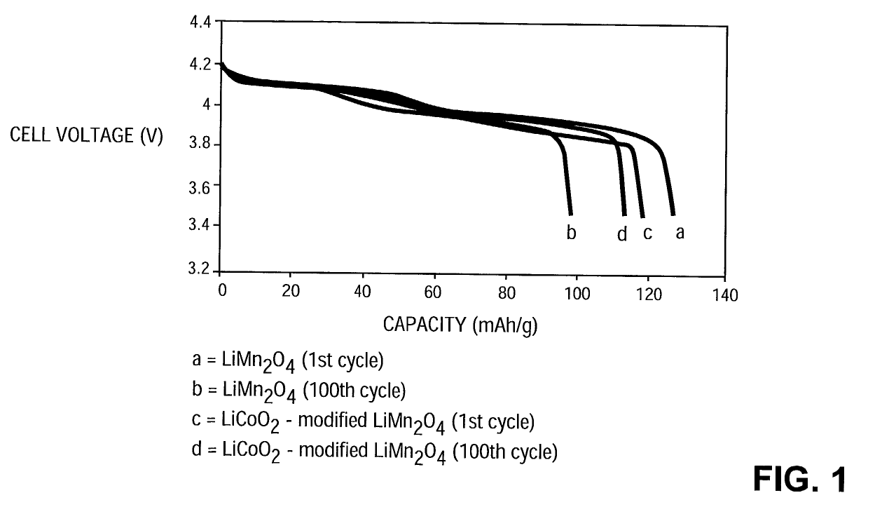

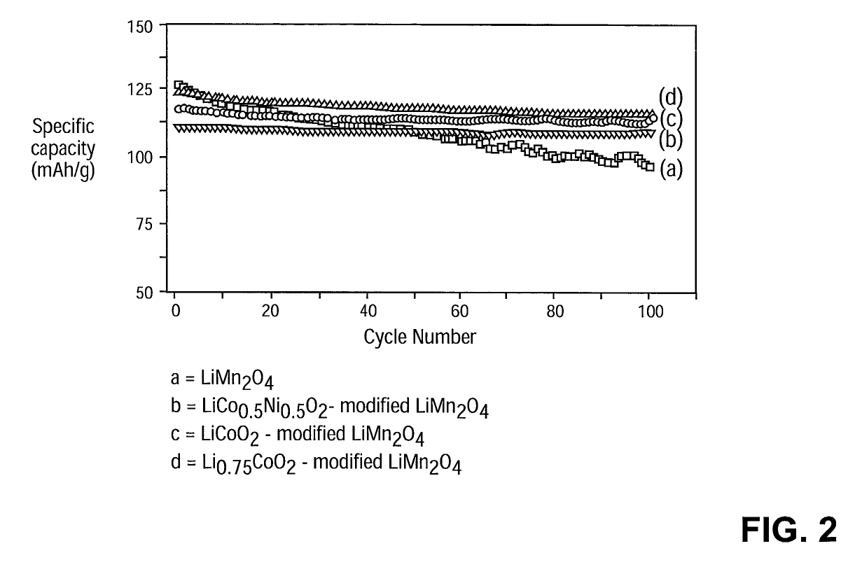

FIG. 1 compares first and 100th discharge profiles of a LiMn₂O₄ and a LiₓCoO₂-modified LiMn₂O₄ cathodes at room temperature at 0.5 mA/cm², which corresponds to C/2 discharge rate. The discharge curves illustrated in FIG. 1 are labeled as follows: (a) LiMn₂O₄ (cycle 1), (b) LiMn₂O₄ (cycle 100), (c) LiCoO₂ modified LiMn₂O₄ (cycle 1), and (d) LiCoO₂ modified LiMn₂O₄ (cycle 100). The surface/chemically modified LiMn₂O₄ exhibits better capacity retention compared to unmodified LiMn₂O₄. FIG. 2 compares the cyclability data of LiMn₂O₄ with those of a number of surface/chemically modified LiMn₂O₄ cathodes (with LiCo_{0.5}Ni_{0.5}O₂, LiCoO₂ and Li_{0.75}CoO₂) up to 100 cycles at a current density of 0.5 mA/cm² (C/2 rate) at room temperature. The cyclability data illustrated in FIG. 2 are labeled as (a) LiMn₂O₄, (b) LiCo_{0.5}Ni_{0.5}O₂-modified LiMn₂O₄, (c) LiCoO₂-modified LiMn₂O₄, and (d) Li_{0.75}CoO₂-modified LiMn₂O₄. As evident from FIGS. 1 and 2, the surface/chemically modified LiMn₂O₄ compositions exhibit excellent cyclability. The percentage capacity fading (over 100 cycles) calculated from the discharge capacity values are given in Table 1. Among all the materials examined, the LiCo_{0.5}Ni_{0.5}O₂-modified LiMn₂O₄ exhibits superior performance with a capacity fading value of less than 0.02% per cycle over 100 cycles. However, the LiCo_{0.5}Ni_{0.5}O₂-modified LiMn₂O₄ sample exhibits lower initial capacity (111 mAh/g) than the unmodified LiMn₂O₄ (127 mAh/g) as seen in Table 1. Additionally, the Li_{0.75}CoO₂ modified sample shows a higher capacity (123 mAh/g) than the LiCoO₂-modified sample (118 mAh/g).

TABLE 1
Specific capacity values (mAh/g) and capacity fading (%) rate for
various surface/chemically modified LiMn₂O₄
and unmodified LiMn₂O₄ samples.

| | Capacity (mAh/g) | | (%) |
|---|---|---|---|
| | 1st | 100th | Capacity |
| | dis- | dis- | Fading per |
| Sample | charge | charge | cycle |
| LiMn₂O₄ at 25° C. (C/2) | 126.5 | 97.13 | 0.232 |
| LiCoO₂-modified LiMn₂O₄ at 25° C. C/2) | 117.5 | 114.29 | 0.027 |
| LiMn₂O₄ at 25° C. (2C) | 118 | 86.66 | 0.266 |
| LiCoO₂-modified LiMn₂O₄ at 25° C. (2C) | 105.7 | 101.4 | 0.040 |
| LiCo_{0.5}Ni_{0.5}O₂-modified LiMn₂O₄ at 25° | 103.73 | 100.11 | 0.034 |
| C. (2C) | | | |
| LiMn₂O₄ at 60° C. (C/2) | 132.8 | 78.43 | 0.409 |
| LiCoO₂-modified LiMn₂O₄ at 60° C. C/2) | 113.1 | 104.63 | 0.075 |
| Li_{0.75}CoO₂-modified LiMn₂O₄ at 25° C. | 123.35 | 115.58 | 0.063 |
| (C/2) | | | |
| LiCo_{0.5}Ni_{0.5}O₂-modified LiMn₂O₄ at 25° | 124.35 | 114.36 | 0.019 |
| C. (C/2) | | | |
| Li_{0.75}CoO₂-modified LiMn₂O₄ at 60° C. | 110.8 | 108.7 | 0.080 |
| (C/2) | | | |
| LiCo_{0.5}Ni_{0.5}O₂-modified LiMn₂O₄ at 60° | 111.5 | 108.3 | 0.028 |
| C. (C/2) | | | |
| Al₂O₃-modified LiMn₂O₄ at 25° C. (C/2) | 131.21 | 124.73 | 0.049 |
| Al₂O₃-modified LiMn₂O₄ at 60° C. (C/2) | 130.27 | 109.23 | 0.161 |
| Cr₂O₃-modified LiMn₂O₄ at 25° C. (C/2) | 133.03 | 109.08 | 0.18 |
| MgO-modified LiMn₂O₄ at 25° C. (C/2) | 136.46 | 126.63 | 0.072 |

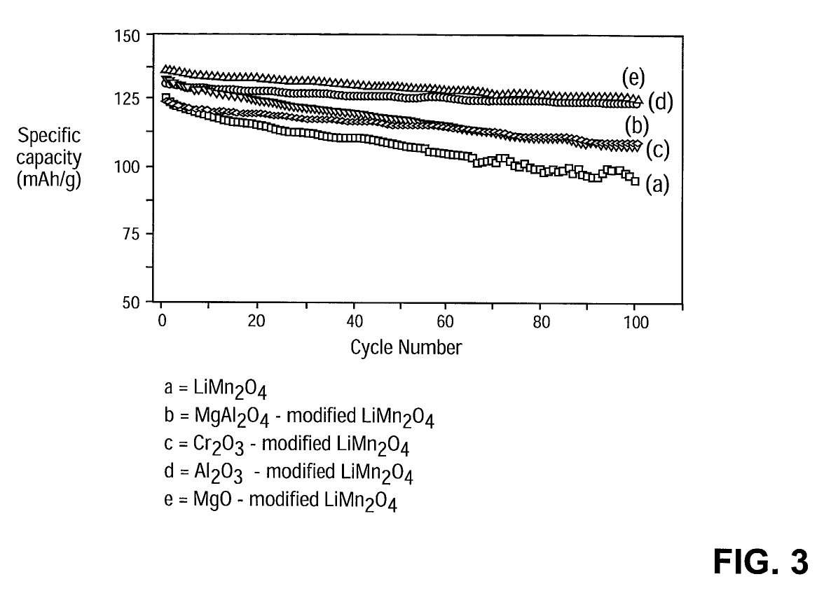

FIG. 3 compares the cyclability data collected with a current density of 0.5 mA/cm² (C/2 rate) at room temperature. The cyclability data illustrated in FIG. 3 are labeled as (a) LiMn₂O₄, (b) MgAl₂O₄-modified LiMn₂O₄, (c) Cr₂O₃-modified LiMn₂O₄, (d) Al₂O₃-modified LiMn₂O₄ and (e) MgO-modified LiMn₂O₄. As seen from Table 1, Al₂O₃ modified LiMn₂O₄ material exhibits higher initial capacity (131 mAh/g) with a least capacity fading of less than 0.05% per cycle over 100 charge/discharge cycles, compared to other materials.

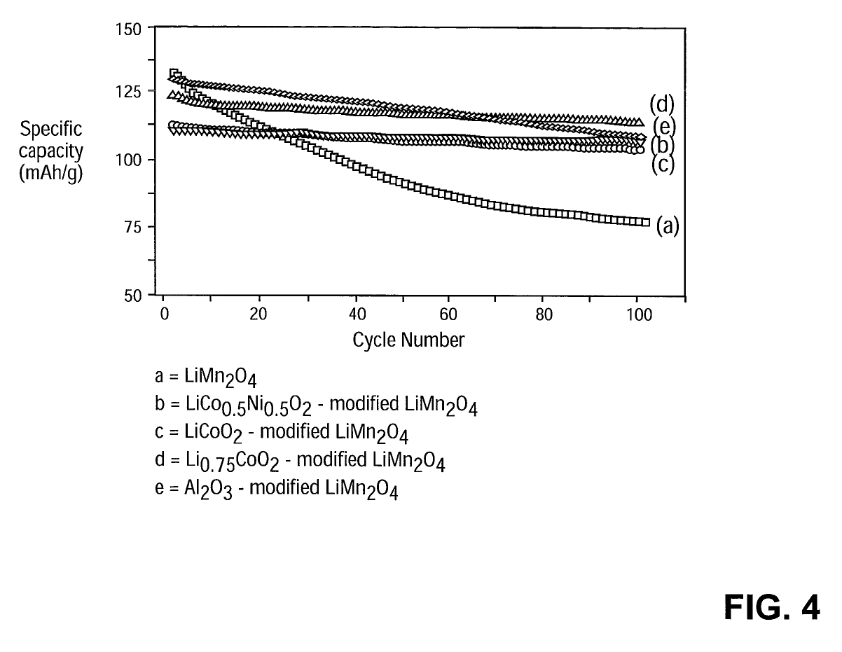

FIG. 4 compares the cyclability data collected at 60° C. with a current density of 0.5 mA/cm² (C/2 rate). The cyclability data illustrated in FIG. 4 are labeled as (a) LiMn₂O₄, (b) LiCo_{0.5}Ni_{0.5}O₂-modified LiMn₂O₄, (c) LiCoO₂-modified LiMn₂O₄, (d) Li_{0.75}CoO₂-modified LiMn₂O₄, and (e) Al₂O₃-modified LiMn₂O₄. The surface/chemically modified LiMn₂O₄ cathodes show a higher capacity retention compared to that of unmodified LiMn₂O₄. As seen in Table 1, the unmodified LiMn₂O₄ cathode shows a capacity fading of 0.41% per cycle over 100 cycles while the surface/chemically modified cathodes show a much lower fade rate. Among all the surface/chemically modified samples, the LiCo_{0.5}Ni_{0.5}O₂-modified LiMn₂O₄ cathode exhibits the lowest fading rate of less than 0.03% per cycle over 100 cycles at 60° C. Among the various materials listed in Table 1, the Li_{0.75}CoO₂ modified LiMn₂O₄ may provide the best combination of high capacity and good cyclability.

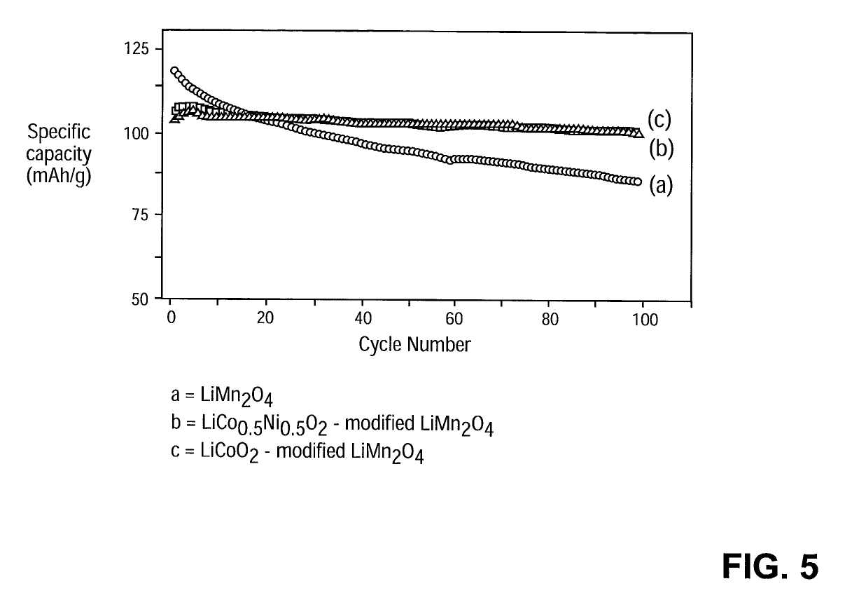

FIG. 5 compares the cyclability data of LiMn₂O₄ and the surface/chemically modified LiMn₂O₄ cathodes at a higher current density of 2 mA/cm² (2C rate) at room temperature. The cyclability data illustrated in FIG. 5 are labeled as (a) LiMn₂O₄, (b) LiCo₀.₅Ni_{0.5}O₂-modified LiMn₂O₄, and (c) LiCoO₂-modified LiMn₂O₄. As evident from FIG. 5, the LiCoO₂-modified LiMn₂O₄ exhibits excellent cyclability and rate capability at room temperature. The percentage capacity fading (over 100 cycles) calculated from the discharge capacity values at 2 mA/cm² (2C rate) are given Table 1.

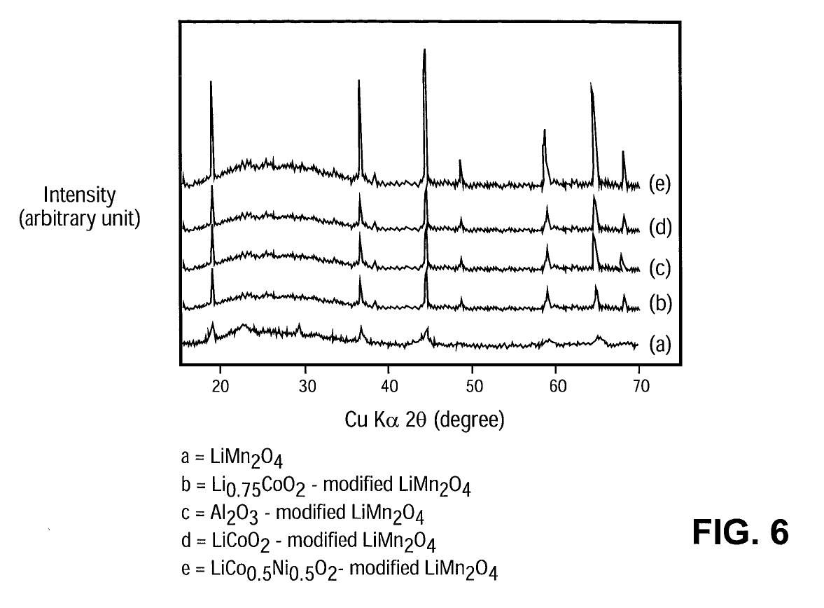

FIG. 6 compares the X-ray diffraction patterns of LiMn₂O₄ and the surface/chemically modified LiMn₂O₄ spinel cathodes in discharged state after cycling at 60° C. over 100 cycles. The X-ray diffraction patterns illustrated in FIG. 6 are labeled as follows: (a) LiMn₂O₄ cathode, (b) Li_{0.75}CoO₂ modified LiMn₂O₄ cathode, (c) Al₂O₃ modified LiMn₂O₄ cathode, (d) LiCoO₂ modified LiMn₂O₄ cathode, and (e) LiCo_{0.5}Ni_{0.5}O₂ modified LiMn₂O₄ cathode. As seen from FIG. 6, unlike the surface/chemically modified LiMn₂O₄, the unmodified LiMn₂O₄ spinel cathode shows peak broadening indicating structural degradation during cycling at elevated temperatures. Similar results are also found for samples soaked in the electrolyte (1M LiPF₆ in EC and DEC) at 55° C. The peak-broadening feature (loss of crystallinity) could be due to the degradation of the particles of LiMn₂O₄ spinel. It is generally known that the crystallinity decreases proportionately with the extent of capacity fading. The surface/chemical modification of LiMn₂O₄ appears to protect the LiMn₂O₄ crystals from attack by the acidic species contained in the electrolyte and thereby leads to the maintenance of the well-defined crystallites during cycling. It may be theorized that the capacity fading of LiMn₂O₄ at elevated temperatures is due to the loss of active material from the surface during cycling.

Transmission electron microscopic (TEM) studies indicate that while the firing at elevated temperatures of around 800° C. leads to a diffusion of the surface modification material into the bulk of the electrode material, the firing at lower temperatures of around 300° C. leads to the presence of a significant amount of the surface modification material on the surface. So the former and latter cases may be termed as chemical modification and surface modification respectively. Thus the process described in this invention may broadly be considered as either surface modification or chemical modification or both depending upon the final firing temperature.

### Example 2

### Surface-Modified LiCoO₂ Cathodes

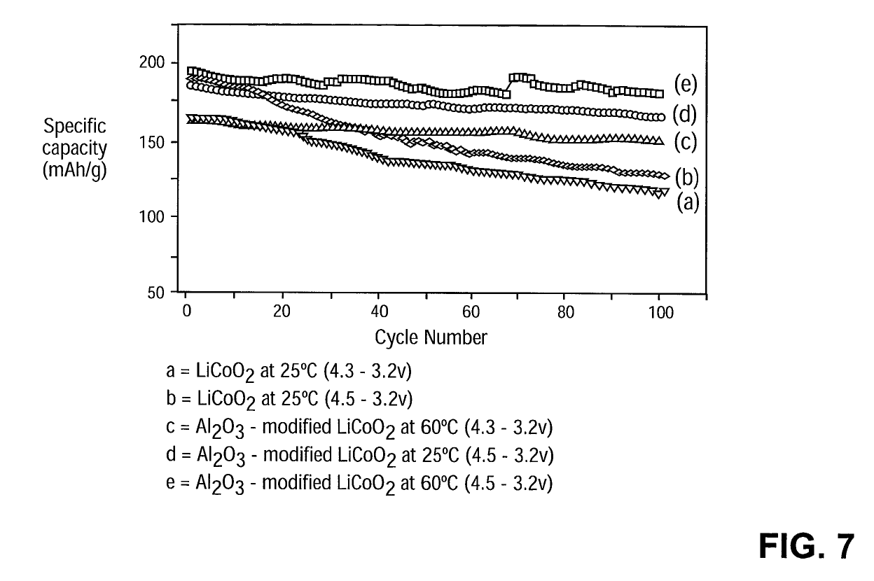

A commercially available LiCoO₂ powder may be used as the electrode material. FIG. 7 compares the cyclability data of LiCoO₂ and Al₂O₃-modified LiCoO₂ at room temperature and at 60° C. in various voltage ranges of 4.3-3.2 and 4.5-3.2 V at C/5 rate. The cyclability data illustrated in FIG. 7 are labeled as (a) LiCoO₂ at 25° C. (4.3-3.2 V), (b) LiCoO₂ at 25° C. (4.5-3.2 V), (c) Al₂O₃-modified LiCoO₂ at 60° C. (4.3-3.2 V), (d) Al₂O₃-modified LiCoO₂ at 25° C. (4.5-3.2 V), and (e) Al₂O₃-modified LiCoO₂ at 60° C. (4.5-3.2 V).

The data reveals that LiCoO₂ suffers from capacity fading severely (FIG. 7(a)) when the charging cut-off voltage is increased to 4.3 V at 25° C. LiCoO₂ cathodes are conventionally cycled up to a charging cut-off voltage of 4.2 V with a capacity of around 140 mAh/g and below 4.2 V it is known to cycle well. On the other hand, Al₂O₃-modified LiCoO₂ does not show any fading during cycling with a voltage range of 4.3-3.2 V. FIG. 7 also shows the cyclability data at 60° C. in the voltage range of 4.3-3.2 V. The Al₂O₃-modified LiCoO₂ does not show any capacity fading during cycling in the voltage range of 4.3-3.2 V at even 60° C. FIG. 7 also shows the cyclability data for Al₂O₃-modified LiCoO₂ at room temperature and at 60° C. in the voltage range of 4.5-3.2 V. The Al₂O₃-modified LiCoO₂ exhibits very good cyclability at elevated temperatures with very little capacity fading. The data show that the unmodified LiCoO₂ cathode exhibits severe capacity fade in the voltage range of 4.5-3.2 V. The good cylability of the Al₂O₃-modified LiCoO₂ up to a charging cut-off voltage of 4.5 V enables to achieve a much higher capacity of around 190 mAh/g compared to the 140 mAh/g generally achieved with unmodified LiCoO₂ cathode.

The capacity fading of unmodified LiCoO₂ at higher voltages could be due to the loss of oxygen and dissolution of cobalt from the lattice. The surface modification with Al₂O₃ seems to suppress these problems and improve the capacity retention at higher cut-off charge voltages. Transmission electron microscopic (TEM) studies show that the Al₂O₃ is present on the surface of LiCoO₂.

What is claimed is:

1. An electrode material comprising a surface/chemically modified positive electrode (cathode) material, wherein the surface/chemical modification is a ceramic.

2. The composition of claim 1, wherein the surface/chemical modification is selected from the group consisting of LiₓNi_{1-y}M_{y}O₂, where 0≦x≦1, 0≦y≦1, and M=Mg, Al, Ti, V, Cr, Fe, Co, Cu, Zn, and Ga; Al₂O₃; Cr₂O₃; MgO; Al_{2-y}Mg_{y}O_{3-0.5y} where 0≦y≦2; Li₁₊ₓMn_{2-x-y}M_{y}O₄ where 0≦x≦0.33, 0≦y≦2 and M=Mg, Al, Ti, V, Cr, Fe, Co, Ni, Cu and Zn; Zr_{1-y}M_{y}O_{2-y} where 0≦y≦1 and M=Mg, Ca; Zr_{1-y}M_{y}O_{2-0.5y} where 0≦y≦1 and M=Sc, Y; and a combinations thereof.

3. The composition of claim 1, wherein the positive electrode (cathode) material is selected from the group consisting of LiCoO₂, LiMn₂O₄, LiNi_{1-y}CO_{y}O₂ where 0≦y≦1 and LiMn_{1-y}M_{y}O₂ where M=Cr and Al and 0≦y≦1, and Li₁₊ₓMn_{2-x-y}M_{y}O_{4-z+δ}X_{z}, where 0≦x≦0.33, 0≦y≦1, 0≦δ≦0.5, M=Mg, Al, Ti, V, Cr, Fe, Co, Ni, Cu and Zn, and X=F and S.

4. The composition of claim 1, wherein the positive electrode (cathode) material is LiMn₂O₄.

5. The composition of claim 1, wherein the positive electrode (cathode) material is LiCoO₂.

6. The composition of claim 1, wherein the surface/chemical modification material is LiₓNi_{1-y}CO_{y}O₂, where 0≦x≦1; 0≦y≦1.

7. The composition of claim 1, wherein the surface/chemical modification material is Al₂O₃.

8. The composition of claim 1, wherein the surface/chemical modification material is MgO.

9. The composition of claim 1, wherein the surface/chemical modification material is MgAl₂O₄.

10. The composition of claim 1, wherein the surface/chemical modification material is Li_{1.05}Mn_{1.9}Ni_{0.05}O₄.

11. The composition of claim 1, wherein the surface/chemical modification material is Cr₂O₃.

12. An electrode material comprising a LiMn₂O₄ spinel oxide having been surface/chemically modified with a surface/chemical modification material selected from the group consisting of LiₓNi_{1-y}CO_{y}O₂, where 0≦x≦1; 0≦y≦1; Al₂O₃; Cr₂O₃; MgO; MgAl₂O₄; and a combinations thereof.

13. The composition of claim 11, wherein the surface/chemical modification material is LiₓNi_{1-y}CO_{y}O₂, where 0≦x≦1; 0≦y≦1.

14. The composition of claim 11, wherein the surface/chemical modification material is Al₂O₃.

15. The composition of claim 11, wherein the surface/chemical modification material is MgO.

16. The composition of claim 11, wherein the surface/chemical modification material is MgAl₂O₄.

17. The composition of claim 11, wherein the surface/chemical modification material is Cr₂O₃.

18. An electrode material comprising a LiCoO₂ layered oxide having been surface/chemically modified with a surface/chemical modification material selected from the group consisting of Al₂O₃; Cr₂O₃; MgO, MgAl₂O₄; Li₁₊ₓMn_{2-x-y}M_{y}O₄ where 0≦x≦0.33, 0≦y≦2 and M=Ni or Co; and a combinations thereof.

19. The composition of claim 17, wherein the surface modification material is Al₂O₃.

20. The composition of claim 17, wherein the surface modification material is Li_{1.05}Mn_{1.9}Ni_{0.05}O₄

21. An electrode material preparation method comprising:
supplying a LiMn₂O₄ spinel oxide electrode material;
mixing the LiMn₂O₄ spinel oxide electrode material with a surface/chemical modification material selected from a group consisting of LiₓNi_{1-y}CO_{y}O₂, where 0≦x≦1; 0≦y≦1; Al₂O₃; Cr₂O₃; MgO; MgAl₂O₄; and combinations thereof; and
heat-treating the mixture to prepare a surface/chemically modified LiMn₂O₄ electrode material.

22. The method of claim 20, wherein the heat-treating is performed at a temperature in the approximate range of 100° C. to 1000° C.

23. The method of claim 20 wherein the heat-treating is performed for approximately 1 to 24 hours.

24. The method of claim 20, wherein the surface/chemical modification material is in the approximate range of 1 to 20 weight percent of the surface/chemically modified LiMn₂O₄ electrode material.

25. An electrode material comprising a surface/chemically modified LiMn₂O₄ spinel oxide said electrode material prepared by a process comprising:
a) refluxion of a precursor solution in glacial acetic acid, wherein the precursor is selected from a group consisting of LiₓCoO₂, LiCo_{0.5}Ni_{0.5}O₂, and Al₂O₃;
b) preparing a precursor solution in water, wherein the precursor is selected from a group consisting of Al₂O₃; Cr₂O₃; MgO, and MgAl₂O₄;
c) dispersing LiMn₂O₄ spinel oxide in the precursor solution; and
d) heating the dispersed LiMn₂O₄ spinel oxide to approximately 100 to 500 degrees C.; and
e) firing the heated dispersed LiMn₂O₄ spinel oxide at 500 to 900 degrees C.

26. A method of preparing an electrode material for lithium-ion batteries comprising:
supplying a LiCoO₂ layered oxide electrode material;
mixing the LiCoO₂ layered oxide electrode material with a surface/chemical modification material selected from a group consisting of Al₂O₃; Cr₂O₃; MgO, MgAl₂O₄; LiₓMn_{2-x-y}M_{y}O₄ where 0≦x≦0.33, 0≦y≦2 and M=Ni or Co; and combinations thereof; and
heat-treating the mixture to prepare a surface/chemically modified LiCoO₂ electrode material.

27. The method of claim 23, wherein the heat-treating is performed at a temperature in the approximate range of 100° C. to 1000° C.

28. The method of claim 23 wherein the heat-treating is performed for approximately 1 to 24 hours.

29. The method of claim 25, wherein the surface/chemical modification material is in the approximate range of 1 to 20 weight percent of the surface/chemically modified LiCoO₂ electrode material.

30. An electrode material comprising a surface/chemically modified LiCoO₂ layered oxide said electrode material prepared by a process comprising:
a) refluxion of a precursor solution in glacial acetic acid, wherein the precursor is selected from a group consisting of Al₂O₃; Cr₂O₃; MgO, MgAl₂O₄; Li₁₊ₓMn_{2-x-y}M_{y}O₄ where 0≦x≦0.33, 0≦y≦2 and M=Ni or Co;
b) preparing a precursor solution in water, wherein the precursor is selected from a group consisting of Al₂O₃; Cr₂O₃; MgO, and MgAl₂O₄;
c) dispersing LiCoO₂ layered oxide in the precursor solution; and
d) heating the dispersed LiCoO₂ layered oxide to approximately 100 to 500 degrees C.; and
e) firing the heated dispersed LiCoO₂ layered oxide at 500-900 degrees C.
